(19) United States
(12) Patent Application Publication
(10) Pub. No.: US 2023/0274717 A1
(43) Pub. Date: Aug. 31, 2023

(54) ELECTRONIC DEVICE HAVING EXPANDABLE DISPLAY AND CONTROL METHOD THEREOF

(71) Applicant: SAMSUNG ELECTRONICS CO., LTD., Suwon-si (KR)

(72) Inventors: Kyunghwa SEO, Suwon-si (KR); Jihyun LEE, Suwon-si (KR)

(21) Appl. No.: 18/310,764

(22) Filed: May 2, 2023

Related U.S. Application Data
(63) Continuation of application No. PCT/KR2021/016157, filed on Nov. 8, 2021.

(30) Foreign Application Priority Data
Nov. 6, 2020 (KR) 10-2020-0147212

(51) Int. Cl. G09G 5/00; G06T 5/00; G06V 40/16; G06Q 30/0601

(52) U.S. Cl. CPC G09G 5/003; G06T 5/001; G06V 40/172; G06Q 30/0641; G06V 2201/02

(57) ABSTRACT

Disclosed are an electronic device having an expandable display and a control method thereof. According to an embodiment, the electronic device performs image analysis on a first work displayed in a first display area of the expandable display, so as to determine a second work related to the first work, and displays the second work in a second display area according to expansion of the expandable display.

### CROSS-REFERENCE TO RELATED APPLICATIONS

This application is a continuation of International Application No. PCT/KR2021/016157 designating the United States, filed Nov. 8, 2021, and claiming priority to Korean Patent Application No. 10-2020-0147212, filed on Nov. 6, 2020, in the Korean Intellectual Property Office. The disclosures of each of these applications are incorporated by reference herein in their entireties for all purposes.

### BACKGROUND

### Field

The disclosure relates to an electronic device with an expandable display and a control method thereof.

### Description of Related Art

With the development of display technologies, various expandable displays are appearing. For example, such an expandable display may be implemented through a flexible display. A flexible display may have flexibility because a plastic film instead of glass is used. The flexible display is not only thin and light, but also strong against impact, may be bent or rolled, and may be manufactured in various shapes. Such flexible displays may also be used in industrial fields in which applying existing glass substrate-based displays is limited or impossible.

### SUMMARY

When an additional display area is activated in response to an expansion of a display, a corresponding display area may be used to expand an existing work or to perform an additional work distinguished from the existing work. If an additional work desired by a user is automatically displayed on the additional display area in response to the expansion of the display, the user may obtain a desired result through a simple control, that is, a display expansion. Therefore, there is a need to suggest, as an additional work, a work that is likely to be actually used by the user in an expanded area of the display.

### Technical Solutions

According to an embodiment, an electronic device includes an expandable display; and a processor configured to perform an image analysis on a first work displayed on a first display area of the expandable display, determine a second work related to the first work based on an analysis result of the image analysis, and display the second work on a second display area in response to an expansion of the expandable display.

The image analysis may include analyzing of visual information appearing in an image of the first work. The analysis result may include an attribute of the image of the first work, and the attribute of the image may include at least one of a category of the image, content information of the image, a category of an object in the image, and an identity of the object in the image.

The processor may be configured to determine the second work by further considering log records previously accumulated in association with the first work. The processor may be configured to consider at least a partial log record related to the analysis result of the image analysis among the log records. Analyzing of the first work, generating of the log record, and determining of the second work may each be performed at a function level of an application. The analysis result may include an attribute of the image of the first work, and the processor may be configured to determine the second work by selectively considering a log record corresponding to the attribute of the image among log records previously accumulated in association with the first work.

When the first work is viewing of a first image through an album application and when an identity of a person in the first image is specified based on the analysis result, the processor may be configured to determine at least one of applying of a preferred correction effect, executing of a preferred application, executing of a preferred function of the preferred application, and sharing with a preferred group as the second work, by selectively considering a log record corresponding to the identity of the person among log records previously accumulated in association with the first work. The identity of the person may include at least one of a user of the electronic device and a child of the user.

When the first work is viewing of a first image through an album application and when an identity of a person in the first image is specified based on the analysis result, the processor may be configured to determine the second work by selectively considering a first log record corresponding to the identity of the person among log records previously accumulated in association with the first work. When the first work is viewing of the first image through the album application and when an object of the first image is specified as a first pet based on the analysis result, the processor may be configured to determine the second work by selectively considering a second log record corresponding to the first pet among the log records previously accumulated in association with the first work. When the first work is viewing of a first image through an album application and when the first image is specified as a group photo based on the analysis result, the processor may be configured to determine sharing with at least one person identified in the group photo as the second work.

When the first work is viewing of first content through a video application and when an attribute of the first content is specified based on the analysis result, the processor may be configured to determine at least one of executing of a preferred application, executing of a preferred function of the preferred application, and providing of related content as the second work, by selectively considering a log record corresponding to the attribute of the first content among log records previously accumulated in association with the first work. When the first work is shopping of a first product through a shopping application and when an attribute of the first product is specified based on the analysis result, the processor may be configured to determine at least one of executing of a preferred application, executing of a preferred function of the preferred application, and providing of related shopping information as the second work, by selectively considering a log record corresponding to the attribute of the first product among log records previously accumulated in association with the first work.

When the expandable display is additionally expanded, the processor may be configured to display a third work related to the second work on a third display area in response to the additionally expanding of the expandable display. The second work may include a plurality of works related to the first work, and the third work may include a combination work of at least two of the plurality of works.

According to an embodiment, a control method of an electronic device includes performing an image analysis on a first work displayed on a first display area of an expandable display; determining a second work related to the first work based on an analysis result of the image analysis; and displaying the second work on a second display area in response to an expansion of the expandable display.

According to the following embodiments, an appropriate additional work related to an existing work may be displayed on an additional display area in response to an expansion of a display. A user may be provided with a necessary additional work by expanding the display, and thus convenience of a user interface may be increased.

### BRIEF DESCRIPTION OF THE DRAWINGS

FIG. 1 is a block diagram illustrating an electronic device in a network environment according to various embodiments;

FIG. 2 is a block diagram illustrating a program according to various embodiments;

FIG. 3 illustrates a control operation of an electronic device in response to an expansion of an expandable display according to various embodiments

FIG. 4 illustrates various expanded states of an expandable display, according to various embodiments

FIG. 5 illustrates a process of deriving additional works through log records, according to various embodiments

FIG. 6 illustrates a process of determining additional works through an image analysis of an existing work, according to various embodiments

FIG. 7 illustrates a process of determining additional works related to a group photo, according to an embodiment.

FIG. 8 illustrates a process of determining additional works related to a shopping work according to an embodiment.

FIG. 9 illustrates a process of determining additional works related to a content viewing work according to an embodiment.

FIG. 10 illustrates a process of determining additional works related to a call work according to an embodiment.

FIG. 11 illustrates a process of determining additional works related to an alarm function according to an embodiment.

FIG. 12 illustrates a control operation of an electronic device in response to an additional expansion of an expandable display according to an embodiment.

FIG. 13 is a flowchart illustrating a control method of an electronic device according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

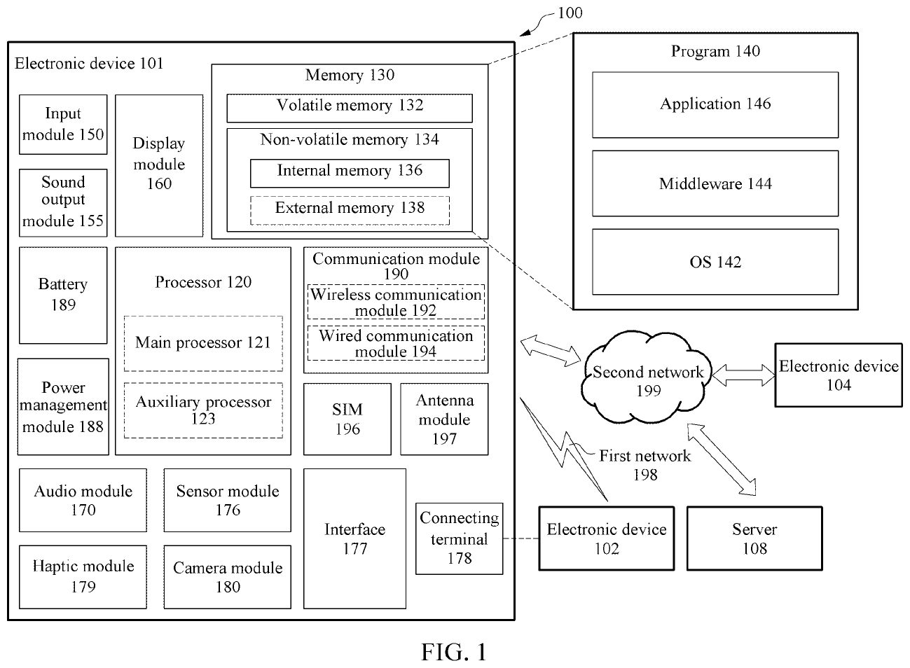

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a portion of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which an artificial intelligence model is executed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch. According to an embodiment, the display module 160 may be an expandable display, such as a foldable display, a rollable display, and a slidable display. For example, the expandable display may be implemented through a flexible display.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more of the external electronic devices 102 and 104, and the server 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least portion of the function or the service requested, or an additional function or an additional service related to the request, and may transfer an outcome of the performing to the electronic device 101. The electronic device 101 may provide the outcome, with or without further processing of the outcome, as at least portion of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

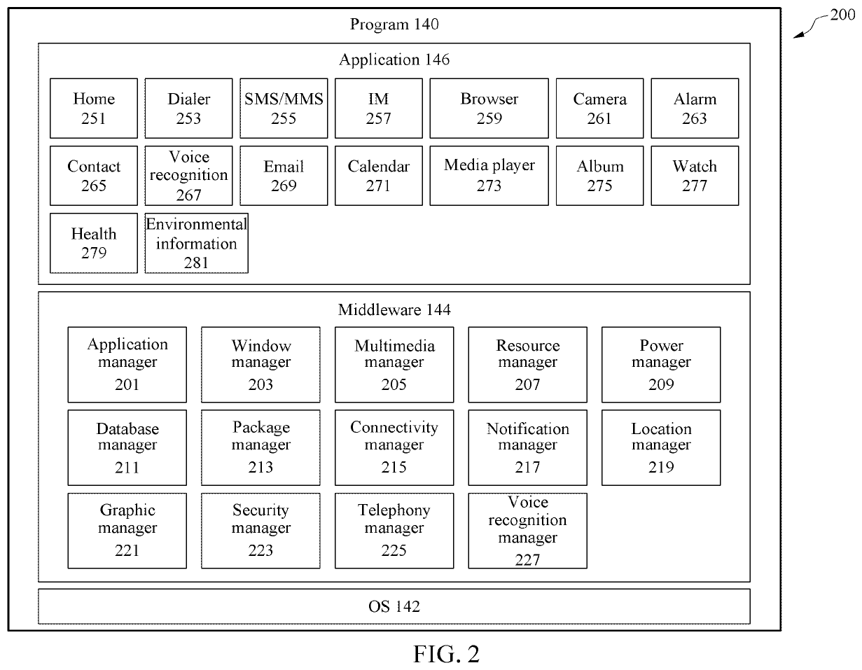

FIG. 2 is a block diagram 200 illustrating a program 140 according to various embodiments. According to an embodiment, the program 140 may include an OS 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocation or deallocation) of one or more system resources (e.g., a process, a memory, or a power source) of the electronic device 101. The OS 142 may additionally or alternatively include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the SIM 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and may determine or provide related information to be used for the operation of the electronic device 101 based on at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, a message, or an alert). The location manager 219, for example, may manage location information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit user's voice data to the server 108, and may receive, from the server 108, a command corresponding to a function to be executed on the electronic device 101 based on at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchange application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of an external electronic device that communicates with the electronic device 101 or a portion of components thereof (e.g., a display module or a camera module of the external electronic device). The device management application may additionally or alternatively support installation, deleting, or updating of an application running on the external electronic device.

The electronic device according to the embodiments disclosed herein may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be understood that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms such as “1st”, “2nd”, or “first” or “second” may simply be used to distinguish the component from other components in question, and do not limit the components in other aspects (e.g., importance or order). It is to be understood that if a component (e.g., a first component) is referred to, with or without the term “operatively” or “communicatively”, as “coupled with”, “coupled to”, “connected with”, or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory”simply refers to the storage medium being a tangible device, and does not include a signal (e.g., an electromagnetic wave), but this term does not differentiate between data being semi-permanently stored in the storage medium and the data being temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

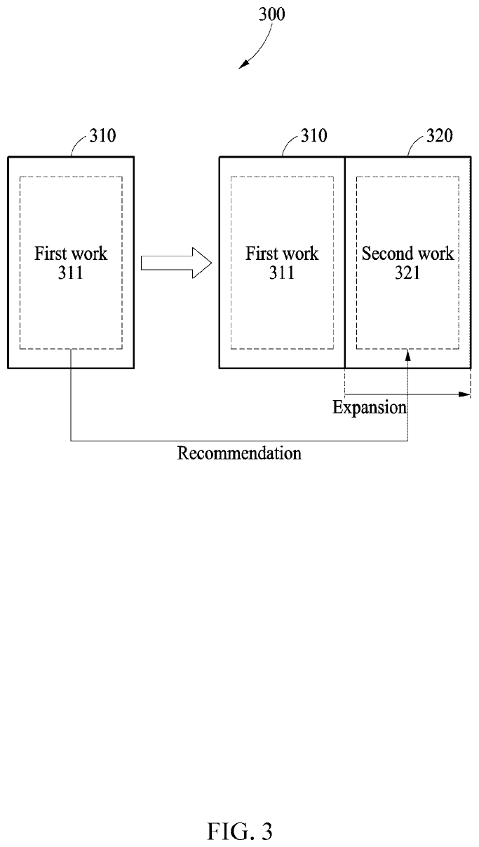

FIG. 3 illustrates a control operation of an electronic device in response to an expansion of an expandable display 300 according to various embodiments. Referring to FIG. 3, the expandable display 300 includes a first display area 310 and a second display area 320. The expandable display 300 may activate the first display area 310 in an unexpanded state and may additionally activate the second display area 320 in an expanded state. In other words, the expandable display 300 may activate both the first display area 310 and the second display area 320 in the expanded state. If a display is expanded, the first display area 310 may be referred to as an existing display area, and the second display area 320 may be referred to as an additional display area. The expandable display 300 may include display areas other than the second display area 320. However, for convenience of description, operations related to the first display area 310 and the second display area 320 are representatively described with reference to the present drawing.

The expandable display 300 may be one of a foldable display, a rollable display, and a slidable display. An expansion of a display may refer to an operation of widening a display area. For example, a rollable display may be expanded when a rolled portion is unfolded, and a foldable display may be expanded when a folded portion is unfolded. In a slidable display, a rolled portion may be unfolded or a covered portion may be exposed and expanded. In response to the above expansion of the display, an additional display area may be activated, and the electronic device may provide an appropriate additional work related to an existing work to the additional display area. Here, the electronic device may refer to the electronic device 101 of FIG. 1, and an operation of the electronic device may correspond to an operation of the electronic device 101 and/or the processor 120.

The electronic device may determine a second work 321 using at least one of image information and a log record related to a first work 311. According to an embodiment, the electronic device may perform an image analysis on the first work 311 displayed on the first display area 310 and determine the second work 321 related to the first work 311 based on an analysis result of the image analysis. The image analysis may include analyzing of visual information appearing in an image, and various image analysis schemes may be used for an image analysis. According to an embodiment, the image analysis may be performed through a machine learning-based artificial intelligence model. The first work 311 may be referred to as an existing work, and the second work 321 may be referred to as an additional work. As will be described in more detail below, analyzing of the first work 311, generating of a log record, and determining of the second work 321 may each be performed at a function level of an application.

The analysis result of the image analysis may include an attribute of an image. For example, the attribute of the image may include at least one of a category of the image, content information of the image, a category of an object in the image, and an identity of the object in the image. The category of the image may include a still image (e.g., a photo, and a picture), video, dynamic video (e.g., leisure video, and sports video), a selfie, children's video, and a group photo. The content information may include information on a category (e.g., movies, music, dramas, broadcasting, and education) of content, genres (e.g., actions, thrillers, dramas, fantasy, popular songs, and classics) of content, a direction, a writer, and a cast member. The category of the object may include people, pets, food, and scenery, and the identity of the object may include a user of an electronic device (e.g., in the case of a selfie), a child (e.g., in the case of a video of a child), and a plurality of persons (e.g., in the case of a group photo). Pets, food, and scenery may also be identified with a predetermined identity.

The electronic device may determine the second work 321 based on the analysis result and display the second work 321 on the second display area 320. For example, when the first work 311 is viewing of a group photo through an album application, the electronic device may verify an identity of at least one person in the group photo through an image analysis, and determine at least one of viewing of other images of the person and sharing the group photo with the person and/or a group to which the person belongs as the second work 321. In addition, the electronic device may determine various other second works 321 based on the analysis result, and embodiments related to the above operation will be described below.

According to an embodiment, the electronic device may determine the second work 321 by considering on a log record related to the first work 311. The image information and the log record related to the first work 311 may be used together, or only one of the image information and the log record may be used. The log record may include detailed information about each work of a detailed function level of an application. In an example, when a user corrects an image and shares the image with another person, an attribute of the image, an application used for the sharing, an application used for the correcting, a correction value, and information of a person who shares the image may be recorded. When an image is shared through an instant messenger application, chat room information of a corresponding application used to share the image may also be recorded. In another example, when a user views content, content information, an application used for viewing the content, and an application used together may be recorded. In addition, environment information such as time, place, and network information may be further recorded as logs. Among the above log records, a log record related to a user may be classified as a user log and managed, and the other logs may be classified as general logs and managed.

As log records are accumulated, predetermined work patterns may be generated for a predetermined work and may be considered in determining the second work 321. For example, when a user frequently uses an application for analyzing cosmetic ingredients when shopping for cosmetics and frequently uses a stock application when viewing investment content, these may be determined as work patterns related to shopping for cosmetics and viewing of investment content, respectively. In consideration of the above patterns, the electronic device may determine an ingredient analysis application as the second work 321 when the first work 311 is shopping for cosmetics, and determine a stock application as the second work 321 when the first work 311 is viewing of an investment image. Other examples related to the above operation may be provided, and embodiments related to the above operation will be described below.

According to an embodiment, the electronic device may selectively consider at least a partial log record related to the analysis result among log records related to the first work 311. Specifically, the log records related to the first work 311 may be classified and stored based on image information (e.g., attributes of an image) of the first work 311, and the electronic device may selectively consider a log record corresponding to specific image information of the first work 311 among the log records. In an example, the first work 311 may be viewing of an image through an album application, and a category of the image may correspond to a selfie. In this example, the electronic device may analyze an application used by a user to correct the selfie, a correction effect, and a target to share the selfie, based on log records related to the selfie. In another example, when the category of the image corresponds to a photo of a child, the electronic device may analyze an application used by the user to correct the photo of the child, a correction effect, and a target to share the photo of the child, based on log records related to the photo of the child. Accordingly, the electronic device may selectively provide the second work 321 based on the image information of the first work 311.

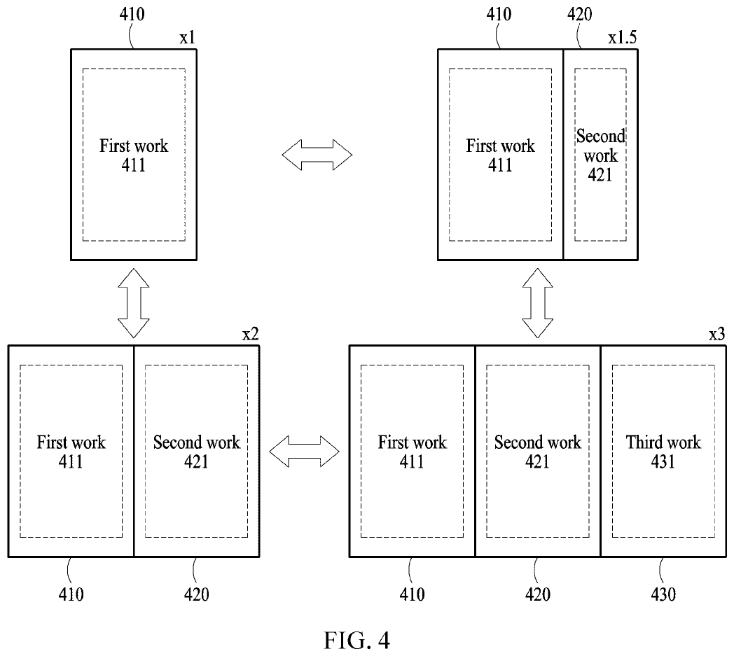

FIG. 4 illustrates various expanded states of an expandable display, according to various embodiments. Referring to FIG. 4, the expanded states of the expandable display include a 1× magnification state (i.e., a default state), a 1.5× magnification state, a 2× magnification state, and a 3× magnification state. The states of FIG. 4 are merely examples, and a state of the expandable display may include only some of the states of FIG. 4 or a larger number of states than the states of FIG. 4. For example, intermediate states, such as 1.3× and 2.5×, of the states of FIG. 4 may be added, or states, such as 0.5× and 4×, out of a magnification range of the states of FIG. 4 may be added.

The state of the expandable display may be freely changed. For example, various state conversions may be possible, for example, a conversion from a 1× state to one of a 1.5× state, a 2× state, and a 3× state; a conversion from a 1.5× state to one of the 1× state, 2× state, and 3× state; and a conversion from a 1× state to a 2× state followed by a conversion to a 1.5× state or a 3× state. Power for the above state conversion may be provided by a user or by a power device of the expandable display. The power device may be driven by a manipulation of a user, or the electronic device may automatically determine a necessity to drive the power device and drive the power device.

When an additional display area is activated in response to the state conversion, the electronic device may display an appropriate additional work on a corresponding area. For example, when an expanded state of the expandable display is converted from the 1× state to the 1.5× state or the 2× state, the electronic device may display a second work 421 related to a first work 411 of a first display area 410 on a second display area 420. When a plurality of second works 421 are present, a small number of second works 421 may be exposed on the second display area 420 in the 1.5× state, in comparison to the second display area 420 in the 2× state. Alternatively, instead of all second works 421 of the second display area 420 being exposed on the second display area 420 in the 1.5× state, the second works 421 may be displayed in a reduced state.

When the expanded state is converted from the 1× state, the 1.5× state, or the 2× state to the 3× state, the electronic device may display a third work 431 on a third display area 430. The third work 431 may be related to the first work 411 and the second work 421. For example, the second work 421 may correspond to a subfunction or detailed function of the first work 411, and the third work 431 may correspond to a subfunction or detailed function of the second work 421. According to an embodiment, the second work 421 may include a plurality of works related to the first work 411, and the third work 431 may include a combination work of at least two of the plurality of works. For example, when the first work 411 is viewing of a selfie, the second work 421 may include correcting of an image using a frequently used effect and sharing of the selfie with another user who frequently shares the selfie, and the third work 431 may include a combination work of sharing an image to which a corresponding preferred correction is applied with corresponding other users.

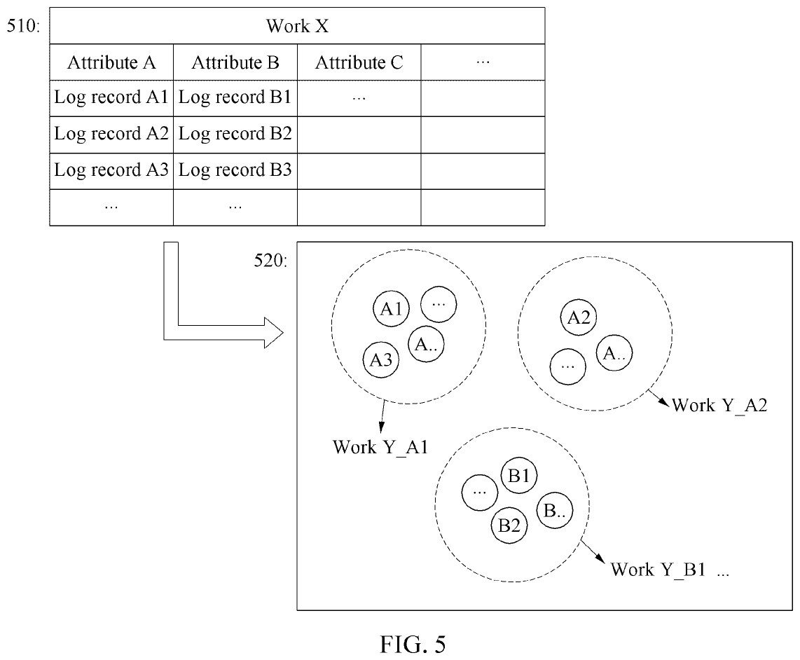

FIG. 5 illustrates a process of deriving additional works through log records, according to various embodiments. Referring to FIG. 5, a dataset 510 stores log records related to a work X. The work X may be one of various works performed through an electronic device. The dataset 510 may classify and store log records of the work X according to attributes. For example, respective log records of the work X may be classified according to attributes A, B, and C, and the like. Although not shown in FIG. 5, log records of a work, for example, a work X′, different from the work X may be stored and classified without classification of the above attributes.

According to an embodiment, attributes may be determined based on image information. For example, the work X may correspond to viewing of an image, and an attribute may include at least one of a category of the image, content information of the image, a category of an object in the image, and an identity of an object in the image. More specifically, the category of the image may include a selfie, an image of a child, and a group photo, and log records may be classified and stored according to attributes such as selfies, images of children, and group photos. For example, the attributes A, B, and C of the work X may be a selfie, an image of a child, and a group photo, respectively. A data space 520 displays each log record of the dataset 510 according to a similarity. Log records corresponding to the same attribute may be very similar to each other and may be displayed in neighboring positions in the data space 520. When log records of a predetermined level or greater are accumulated in association with a predetermined attribute, the accumulated log records may form one work pattern, and an additional work may be determined according to a corresponding work pattern.

In an example, if log records related to using of a specific correction application during viewing of a selfie are accumulated, one work pattern may be formed by clustering the log records. Similarly, log records related to using of a specific correction effect may also be clustered to form one working pattern. In another example, log records related to sharing of an image with a specific group (e.g., family) during viewing of an image of a child may also be clustered to form one work pattern. In the data space 520, log records (e.g., A1, A3, etc.) may correspond to a work of using a specific correction application during viewing of a selfie, log records (e.g., A2, etc.) may correspond to a work of using a specific correction effect during the viewing of the selfie, and log records (e.g., B1, B2, etc.) may correspond to a work of sharing an image with a specific group during viewing of an image of a child. As the log records are clustered as described above, works Y_A1 and Y_A2 for the attribute A of the work X, and a work Y_B1 for the attribute B may be determined as additional works. The electronic device may display at least some of the above additional works on an additional display area.

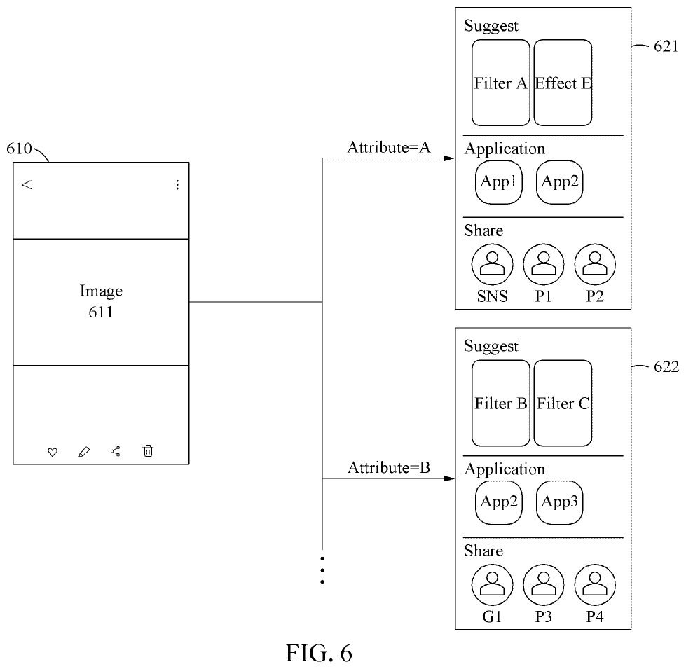

FIG. 6 illustrates a process of determining additional works through an image analysis of an existing work, according to various embodiments. Referring to FIG. 6, second display areas 621 and 622 are illustrated. If a display area is expanded in a state in which an image 611 is displayed on a first display area 610, one of the second display areas 621 and 622 may be additionally provided. The image 611 may be a still image or a video, and the existing work may be viewing of the image 611 through an album application.

The electronic device may determine an additional work based on an analysis result of the image 611 and display the additional work on an additional display area. For example, when an attribute of the image 611 is A, the electronic device may display an additional work of the second display area 621. When an attribute of the image 611 is B, the electronic device may display an additional work of the second display area 622. As described above, other additional works may be selected according to attributes of the image 611. In the second display areas 621 and 622, works with relatively high frequencies and preference levels may be displayed on a left side of a screen, and may be referred to as a first-rank additional work, a second-rank additional work, and the like from the left. Filters A and B may also be referred to as a first-rank correction work, and a second-rank correction work, respectively. When a number of additional works to be exposed is tried to be reduced in a 1.5× magnification state in comparison to a 2.0× magnification state, an additional work with a relatively high priority may be exposed first. For example, only a first-rank additional work in each category may be exposed.

If the attribute of the image 611 is A, correction works Filter A and Effect E may be suggested as additional works. The correction works Filter A and Effect E may be suggested in a manner of displaying images (an image to which the filter A is applied and an image to which the effect E is applied) to which corrections are applied. The correction works Filter A and Effect E may correspond to corrections frequently used for the attribute A, that is, preferred corrections. In addition, works of applications App1 and App2 may be displayed as additional works related to the attribute A. The applications App1 and App2 may correspond to applications frequently used for the attribute A, that is, preferred applications. The works of the applications App1 and App2 may include a work of execution of each application or a work of execution of a specific function of each application. In addition, a sharing work with targets SNS, P1, and P2 for sharing may be displayed as an additional work related to the attribute A. If the target SNS is selected, sharing may be performed through an SNS. If the targets P1 and P2 are selected, sharing with the targets P1 and P2 may be performed through a sharing application. For example, the sharing application may include an instant messenger application. The targets SNS, P1, and P2 may correspond to targets that a user frequently shares an image of the attribute A, that is, preferred sharing targets.

When the attribute is B, works of preferred correction works Filter B and Filter C, preferred applications App2 and App3, and preferred sharing targets G1, P3, and P4 may be displayed as additional works. Here, P represents a person and G represents a group. For example, the sharing target G1 may be a group including the sharing targets P1 and P2. As shown in FIG. 6, at least a portion of additional works suggested for the attribute B may differ from those suggested for the attribute A. This is because work patterns of a user for each attribute may be different and are reflected to determine an additional work. Hereinafter, examples of additional works according to detailed attributes of the image 611 when the image 611 is viewed through the album application will be described in more detail.

According to an embodiment, an identity of a person in an image may be specified based on an image analysis. For example, the attribute A may be a user of an electronic device (e.g., in the case of a selfie), and the attribute B may be a child (e.g., in the case of an image of a child). The electronic device may determine at least one of applying of a preferred correction effect, executing of a preferred application, executing of a preferred function of the preferred application, and sharing with a preferred group as an additional work, by selectively considering a log record corresponding to an identity of a person among log records previously accumulated in association with a work of viewing an image through an album application. For example, when an identity is verified as a user of the electronic device, the electronic device may select a correction work (e.g., a filter to brighten a skin tone, and an effect to increase an eye size), an application work (e.g., executing of a correction application), and sharing targets (e.g., friends), based on log records corresponding to the user. When the identity is verified as a child of the user, the electronic device may select a correction work (e.g., an effect to show age, and an effect to show a sticker), an application work (e.g., uploading to a childcare application), and sharing targets (e.g., a family group), based on log records corresponding to the child.

According to other embodiments, a category of an object in an image may be specified based on the image analysis. For example, the attribute A may be a person and the attribute B may be a pet. If an identity of a person is specified, the electronic device may determine an additional work by selectively considering a log record corresponding to the identity among log records previously accumulated in association with viewing of an image. If a pet is specified, the electronic device may determine an additional work by selectively considering a log record corresponding to the pet among the log records previously accumulated in association with the viewing of the image. In another example, attributes (a category of an object) may be food and scenery. In this example, to determine an additional work, a log record corresponding to each attribute may be considered. If an attribute (a category of an image) is a dynamic video, additional works may include a work of extracting a section meeting an extraction condition, a work of creating a slow-motion video of extracted images, and a work of sharing each image. For example, the extraction condition may include an action (e.g., running) and an emotion (e.g., a smiling expression).

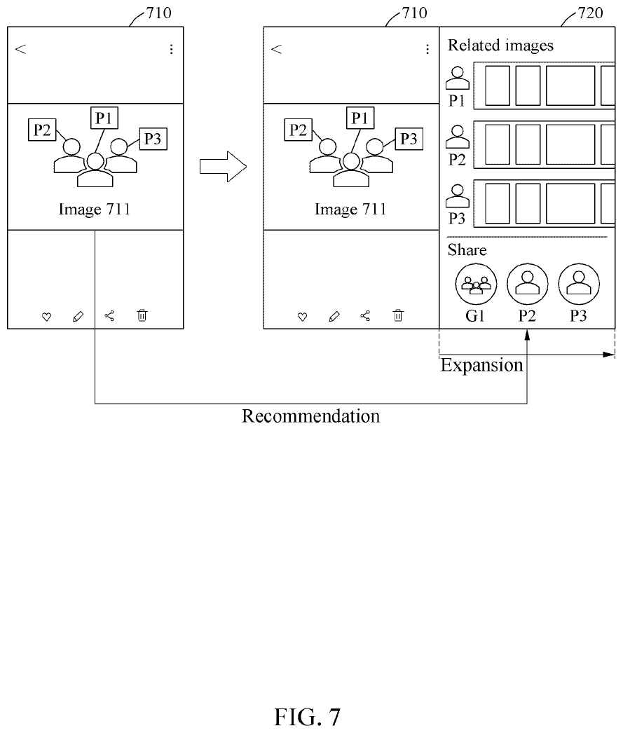

FIG. 7 illustrates a process of determining additional works related to a group photo, according to an embodiment. Referring to FIG. 7, in a state in which an image 711 is displayed on a first display area 710, a display area is expanded. An existing work may be viewing of the image 711 through an album application. An electronic device may determine an additional work through an image analysis and display the additional work on a second display area 720. For example, the electronic device may specify a category of the image 711 as a group photo through the image analysis and verify an identity of each person included in the image 711. The electronic device may determine a work for viewing related images of at least one person identified in the image 711 and a work for sharing the image 711 with at least one person identified in a group photo, as additional works, based on an analysis result of the image analysis.

In an example of FIG. 7, persons P1, P2, and P3 are identified in the image 711, and an additional work for viewing related images of each of the persons P1, P2, and P3 and an additional work for sharing images with the persons P2 and P3 and a group G1 including the persons P1, P2 and P3 are displayed. If a user frequently shares a group photo of the persons P1, P2, and P3 through a group chat room of the persons P1, P2, and P3 in an instant messenger application, the above work pattern may be accumulated as log records. The electronic device may identify the above work pattern based on the log records and determine a work of sharing a group photo through a corresponding chat room as an additional work. To this end, detailed information such as a chat room of a corresponding application as well as an application used to share an image of a predetermined attribute may be stored as log records.

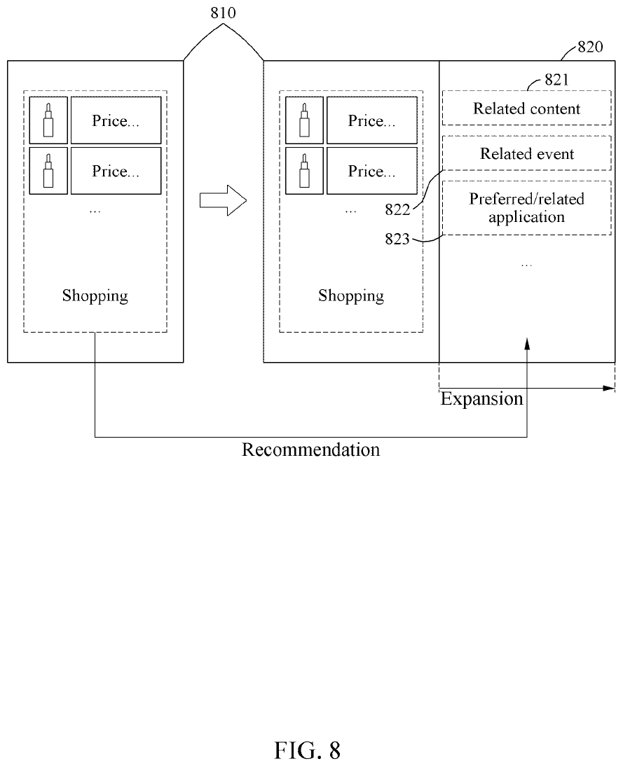

FIG. 8 illustrates a process of determining additional works related to a shopping work according to an embodiment. Referring to FIG. 8, in a state in which a shopping work is performed through a first display area 810, a display area is expanded. An existing work may be shopping for cosmetics through a shopping application. The shopping application may refer to various applications for enabling shopping works, such as, an application exclusive for shopping, and a general-purpose browser. The electronic device may determine an additional work through an image analysis and display the additional work on a second display area 820. For example, the electronic device may specify attributes of a target product for shopping through the image analysis, and may determine at least one of executing of a preferred application, executing of a preferred function of the preferred application, and providing of related shopping information as an additional work, by selectively considering log records corresponding to corresponding product attributes among log records.

In an example of FIG. 8, related content 821 and a related event 822 may be provided as related shopping information, and a preferred application and/or a preferred function may be executed through a preferred/related application 823. A product attribute may include a product category, a product price, and a product brand. For example, in the example of FIG. 8, the product attribute may be determined as cosmetics. In this example, an additional work may be determined through log records related to the cosmetics. For example, when shopping for cosmetics, a user may search for related content or a related event, or frequently use a specific application (e.g., a cosmetic ingredient analysis application). In this example, content, such as introductions and reviews of a corresponding cosmetic product, may be displayed as the related content 821, a discount event related to the corresponding cosmetic product may be displayed as the related event 822, or a cosmetic ingredient analysis application may be displayed as the preferred/related application 823.

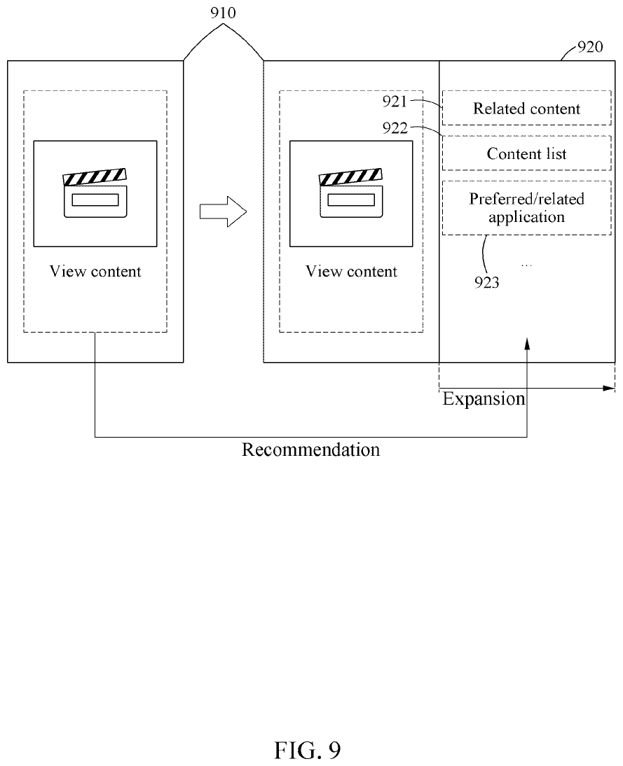

FIG. 9 illustrates a process of determining additional works related to a content viewing work according to an embodiment. Referring to FIG. 9, in a state in which viewing of content is performed through a first display area 910, a display area is expanded. An existing work may be viewing of content through a content playback application. The content playback application may include various applications that provide content playback functions, such as a music application, a video application, a streaming application, and an album application. The electronic device may determine an additional work through an image analysis and display the additional work on a second display area 920. For example, the electronic device may specify attributes of content through the image analysis, and may determine at least one of executing of a preferred application, executing of a preferred function of the preferred application, and providing of related content as an additional work by selectively considering log records corresponding to attributes of corresponding content among log records.

In an example of FIG. 9, related content 921, a content list 922, and a preferred/related application 923 may be displayed as additional works. Content attributes may include information on a category of content (e.g., movies, music, dramas, broadcasting, and education), genres (e.g., actions, thrillers, dramas, fantasy, popular songs, and classics) of content, a direction, a writer, and a cast member, and the related content 921 may be configured based on the above content attributes. For example, the related content 921 may include a movie of the same actor, a movie of the next season, and a movie of the same director in association with a movie being watched, may include music of the same composer and music of the same singer in association with music being listened to, or may include book information or other content in association with investment content being studied. The content list 922 may include content according to a tendency of a user. To analyze the tendency, time zones such as morning/afternoon, and weekdays/weekends, and/or places such as company/transportation/home may be considered. For example, a tendency to listen to music at home on a weekend and a tendency to listen to music at an office may be considered. If a user frequently uses an application, such as a stock application, a real estate application, a household account book application, and a memo application, while viewing investment content, the application may be displayed as the preferred/related application 923.

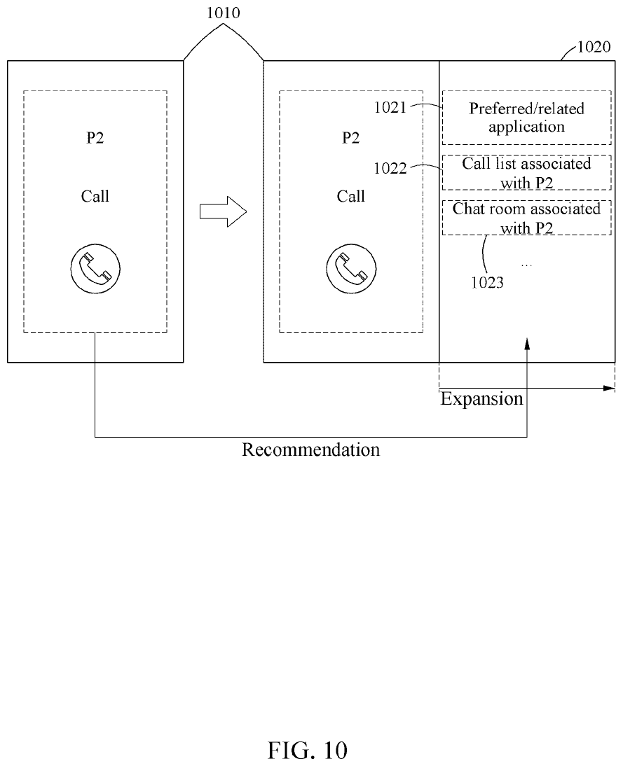

FIG. 10 illustrates a process of determining additional works related to a call work according to an embodiment. Referring to FIG. 10, in a state in which a phone call with a person P2 is performed through a first display area 1010, a display area is expanded. An electronic device may determine an additional work related to the phone call with the person P2 and display the additional work on a second display area 1020. According to an embodiment, the electronic device may analyze log records related to various works performed previously by a user together with a phone call, and/or various other functions previously performed in association with the person P2, and determine an additional work. For example, when the user frequently uses a calendar application or a memo application during a phone call, the electronic device may analyze the frequently used application based on log records and display the frequently used application as a preferred/related application 1021. In addition, the electronic device may further display a call list 1022 and a chat window 1023 associated with the person P2.

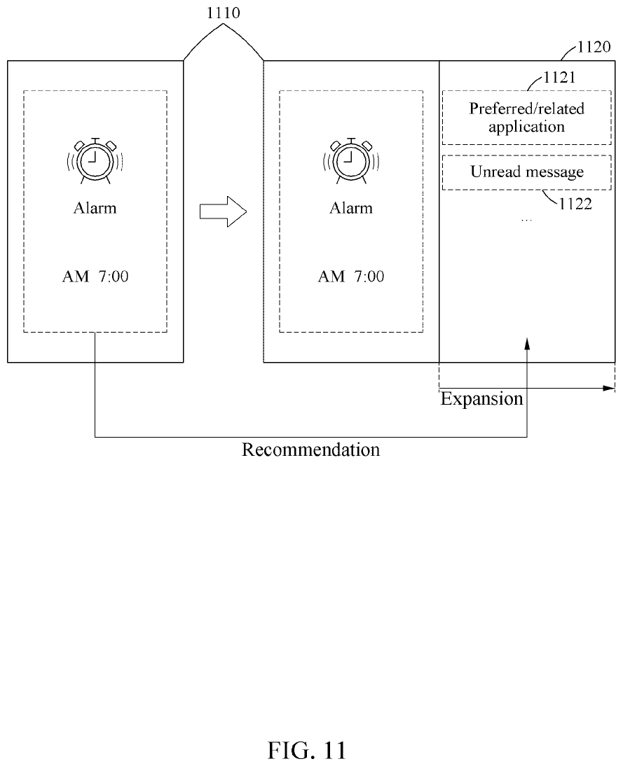

FIG. 11 illustrates a process of determining additional works related to an alarm function according to an embodiment. Referring to FIG. 11, in a state in which an alarm function is executed through a first display area 1110, a display area is expanded. An electronic device may determine an additional work related to the alarm function and display the additional work on a second display area 1120. According to an embodiment, the electronic device may analyze log records related to various works performed previously by a user together with the alarm function, and determine an additional work. For example, when the user frequently checks the weather or news while the alarm function is being executed, the electronic device may analyze the weather or news based on log records and display related applications as preferred/related applications 1121. In addition, the electronic device may further display an unread message 1122 of various applications (e.g., an SNS, an instant message, SMS/MMS, an e-mail, and a game).

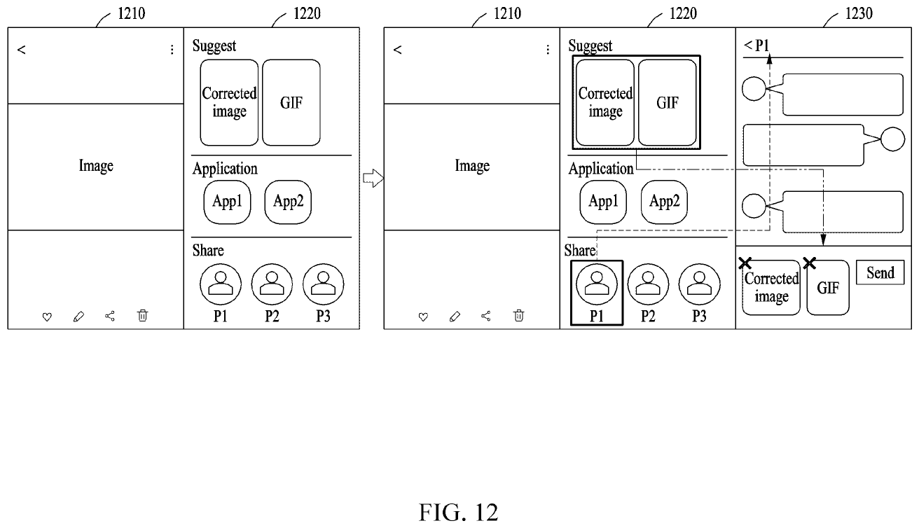

FIG. 12 illustrates a control operation of an electronic device in response to an additional expansion of an expandable display according to an embodiment. Referring to FIG. 12, the expandable display being in a 2× expansion state is additionally expanded to a 3× expansion state. The display provides a first display area 1210 and a second display area 1220 in the 2× expansion state, and additionally provides a third display area 1230 in the 3× expansion state. An electronic device may determine a third work of the third display area 1230 based on a second work of the second display area 1220. For example, the third work may correspond to a subfunction or a detailed function of the second work.

According to an embodiment, the second work may include a plurality of works related to a first work, and the third work may include a combination work of at least two of the plurality of works. In an example of FIG. 12, the first work is viewing of an image, and the second work includes a preferred correction work (in the case of a video, a graphics interchange format (GIF) conversion may be preferred), a preferred application work, and a sharing work with a preferred sharing target. The electronic device may determine a combination of the preferred correction work and the sharing work as the third work. Accordingly, the third work may be a combination work of sharing an image to which a preferred correction is applied with a preferred sharing target. Here, as shown in FIG. 12, a chat room with a sharing target (e.g., P1, a first-rank sharing target) may be displayed on the third display area 1230 for the third work, and a preferred correction image may be automatically attached to an input window to increase convenience. Each preferred correction image may be deleted using a button X. A user may transmit a preferred correction image to a sharing target by simply pressing a send button. If the user desires to send only some preferred correction images, he or she may delete an image he does not want to share by pressing the button X.

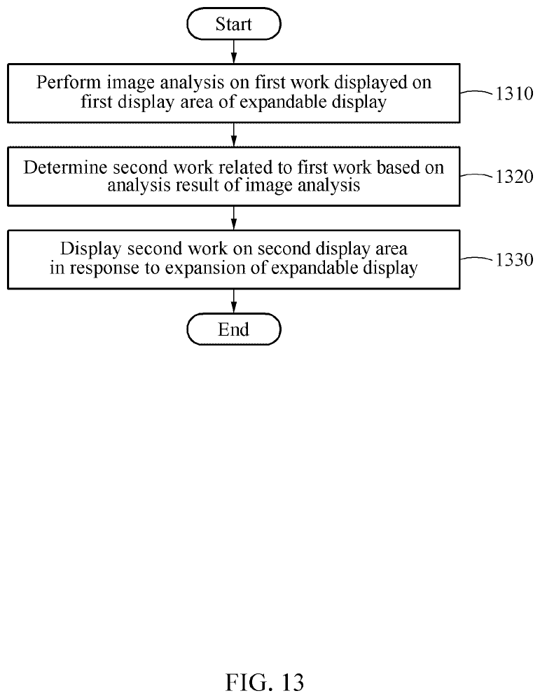

FIG. 13 is a flowchart illustrating a control method of an electronic device according to an embodiment. Referring to FIG. 13, in operation 1310, the electronic device performs an image analysis on a first work displayed on a first display area of an expandable display. The image analysis may include analyzing of visual information appearing in an image of the first work. In operation 1320, the electronic device determines a second work related to the first work based on an analysis result of the image analysis. The analysis result may include an attribute of the image of the first work, and the electronic device may determine the second work by further considering log records previously accumulated in association with the first work. Here, a processor may consider at least a partial log record related to the analysis result of the image analysis among the log records. In operation 1330, the electronic device may display the second work on a second display area in response to an expansion of the expandable display. When the expandable display is additionally expanded, the processor may display a third work related to the second work on a third display area in response to the additionally expanding of the expandable display. In addition, the description provided with reference to FIGS. 1 through 12 may also be applicable to the control method of the electronic device.

What is claimed is:

1. An electronic device comprising:
an expandable display; and
a processor configured to:
perform an image analysis on a first work displayed on a first display area of the expandable display,
determine a second work related to the first work based on an analysis result of the image analysis, and
display the second work on a second display area in response to an expansion of the expandable display.

2. The electronic device of claim 1, wherein
the image analysis comprises analyzing of visual information appearing in an image of the first work,
the analysis result comprises an attribute of the image of the first work, and
the attribute of the image comprises at least one of a category of the image, content information of the image, a category of an object in the image, and an identity of the object in the image.

3. The electronic device of claim 1, wherein the processor is configured to:
determine the second work by further considering at least a partial log record related to the analysis result of the image analysis among log records previously accumulated in association with the first work, and
analyzing of the first work, generating of the log record, and determining of the second work are each performed at a function level of an application.

4. The electronic device of claim 1, wherein
the analysis result comprises an attribute of an image of the first work, and
the processor is configured to determine the second work by selectively considering a log record corresponding to the attribute of the image among log records previously accumulated in association with the first work.

5. The electronic device of claim 1, wherein
the processor is configured to, when the first work is viewing of a first image through an album application and when an identity of a person in the first image is specified based on the analysis result, determine at least one of applying of a preferred correction effect, executing of a preferred application, executing of a preferred function of the preferred application, and sharing with a preferred group as the second work, by selectively considering a log record corresponding to the identity of the person among log records previously accumulated in association with the first work, and
the identity of the person comprises at least one of a user of the electronic device and a child of the user.

6. The electronic device of claim 1, wherein the processor is configured to:
when the first work is viewing of a first image through an album application and when an identity of a person in the first image is specified based on the analysis result, determine the second work by selectively considering a first log record corresponding to the identity of the person among log records previously accumulated in association with the first work; and
when the first work is viewing of the first image through the album application and when an object of the first image is specified as a first pet based on the analysis result, determine the second work by selectively considering a second log record corresponding to the first pet among the log records previously accumulated in association with the first work.

7. The electronic device of claim 1, wherein the processor is configured to, when the first work is viewing of a first image through an album application and when the first image is specified as a group photo based on the analysis result, determine sharing with at least one person identified in the group photo as the second work.

8. The electronic device of claim 1, wherein the processor is configured to, when the first work is viewing of first content through a video application and when an attribute of the first content is specified based on the analysis result, determine at least one of executing of a preferred application, executing of a preferred function of the preferred application, and providing of related content as the second work, by selectively considering a log record corresponding to the attribute of the first content among log records previously accumulated in association with the first work.

9. The electronic device of claim 1, wherein the processor is configured to, when the first work is shopping of a first product through a shopping application and when an attribute of the first product is specified based on the analysis result, determine at least one of executing of a preferred application, executing of a preferred function of the preferred application, and providing of related shopping information as the second work, by selectively considering a log record corresponding to the attribute of the first product among log records previously accumulated in association with the first work.

10. The electronic device of claim 1, wherein
when the expandable display is additionally expanded, the processor is configured to display a third work related to the second work on a third display area in response to the additionally expanding of the expandable display,
the second work comprises a plurality of works related to the first work, and
the third work comprises a combination work of at least two of the plurality of works.

11. A control method of an electronic device, the method comprising:
performing an image analysis on a first work displayed on a first display area of an expandable display;
determining a second work related to the first work based on an analysis result of the image analysis; and
displaying the second work on a second display area in response to an expansion of the expandable display.

12. The method of claim 11, wherein
the analysis result comprises an attribute of an image of the first work, and
the attribute of the image comprises at least one of a category of the image, content information of the image, a category of an object in the image, and an identity of the object in the image.

13. The method of claim 11, wherein the determining of the second work comprises considering at least a partial log record related to the analysis result of the image analysis among log records previously accumulated in association with the first work.

14. The method of claim 11, wherein
the determining of the second work comprises, when the first work is viewing of a first image through an album application and when an identity of a person in the first image is specified based on the analysis result, determining at least one of applying of a preferred correction effect, executing of a preferred application, executing of a preferred function of the preferred application, and sharing with a preferred group as the second work, by selectively considering a log record corresponding to the identity of the person among log records previously accumulated in association with the first work, and
the identity of the person comprises at least one of a user of the electronic device and a child of the user.

15. The method of claim 11, further comprising:
when the expandable display is additionally expanded, displaying a third work related to the second work on a third display area in response to the additionally expanding of the expandable display,
wherein the second work comprises a plurality of works related to the first work, and the third work comprises a combination work of at least two of the plurality of works.
